(19) United States
(12) Patent Application Publication
(10) Pub. No.: US 2002/0172830 A1
(43) Pub. Date: Nov. 21, 2002

(54) Reflector

(76) Inventors: Ulrich Zirfas, Bad Gandersheim (DE); Rolf Meyer, Bad Gandersheim (DE)

Correspondence Address: BAKER & DANIELS, 111 E. WAYNE STREET, SUITE 800, FORT WAYNE, IN, 46802

(21) Appl. No.: 10/124,849

(22) Filed: Apr. 18, 2002

(30) Foreign Application Priority Data
Apr. 19, 2001 (DE) 101 19 124.3

(51) Int. Cl. B32B 15/04

(52) U.S. Cl. 428/434; 428/433

(57) ABSTRACT

The invention relates to a reflector, which exhibits a silver-containing layer on the exterior. A reflector, which is coated in such a way, transmits no UV rays through the housing.

The invention relates to a reflector, in particular for a stationary application. The inner surface is generally coated. Its inner surface can be shaped facet-like.

Reflectors of the kind mentioned are used in the automotive industry. In addition, they have stationary applications, for example in business premises as well as within the general lighting area, furthermore with video devices and as stage spotlights.

Ultraviolet rays are created within the area of such reflectors. The ultraviolet rays are not reflected and emerge through the housing.

It has been evident that lixiviation of the housing takes place when the ultraviolet rays emerge. This results in an embrittlement and a local deformation of the housing components. The deformation makes the housing components useless for the internal area after a short time.

It is an object of the invention to provide a reflector which can be operated over longer periods of time, and whose surrounding field contains synthetic materials, without the synthetic material embrittling or becoming deformed.

The inventors discovered the following:

The well-known metal oxide vaporized mirrors, with which reflectors of well-known designs are coated, reflect in the desired way a substantial part of the light, so that it emerges through the large opening of the reflector, and transmits the IR radiation through the wall of the shell. However, a part of the UV radiation created by the lamp is transmitted through the shell as well, so that this UV radiation lixiviates the synthetic materials of the components of the surrounding field of the reflector and thus makes them inefficient.

According to the measure of the invention lixiviation, fading or degradation of plastic materials are avoided. The invention thus makes it possible to use synthetic materials in cases of need, where this was not possible before. So even the components, which surround the reflector, can be made of synthetic materials. Thus all benefits that synthetic materials offer can be used: that is low weight and low costs.

Silver diffusion color according to the invention can be applied in any way to the exterior of the reflector, for example by immersion, spraying, painting, thus by means of economical techniques. If the reflector consists of glass, and protecting components that are outside of the reflector is all that matters, then the silver diffusion color is applied on the external surface of the shell of the reflector.

Generally besides the silver diffusion color also coating of the inner surface of the shell will be carried out, depending upon the special requirements and the desired function of the reflector.

The invention is described more detailed using the drawing. The following is shown in the drawing in detail:

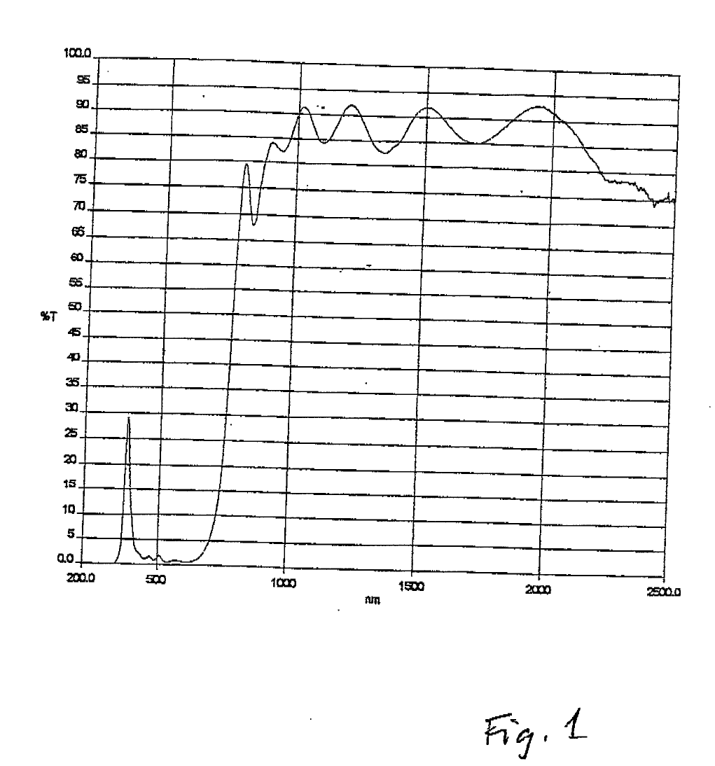

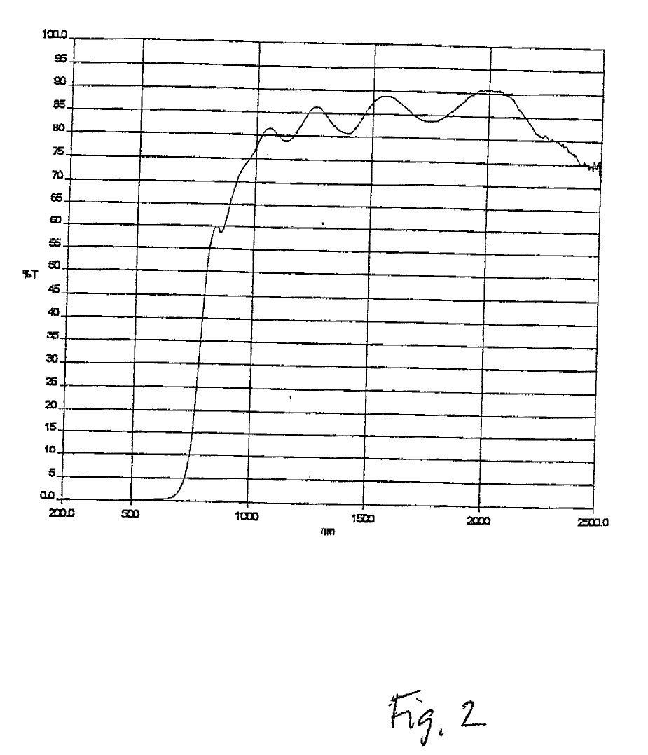

FIGS. 1 and 2 show the percental permeability, shown over the measured wavelengths.

FIG. 1 pictorializes the measurement taken on a reflector without a silver-containing layer. Within the UV range of 350 nm a permeability of 28% was measured. In the visible range the permeability is below 2%.

FIG. 2 shows the measurement taken on a reflector according to the invention, which exhibits a silver-containing layer on its exterior. In the UV range the permeability is about 0%. The same result is achieved within the visible range.

1. Reflector, which exhibits a silver-containing layer on the exterior.

2. Reflector according to claim 1, whereby the silver-containing layer is created by a silver diffusion color

3. Reflector according to claim 1 or 2, whereby silver diffusion color is applied by spraying, painting or immersion.

4. Technique for applying a silver-containing layer on the external surface of a reflector by spraying, painting or immersion and following annealing.

5. Use of a reflector, whose exterior is coated with a silver-containing layer, in a stationary range.
